(19) United States
(12) Patent Application Publication
(10) Pub. No.: US 2005/0047120 A1
(43) Pub. Date: Mar. 3, 2005

(54) Lighting system for an interior of a clothing accessory or an article of clothing and a method of manufacture thereof

(76) Inventor: Peter Alexander Sargent, Aptos, CA (US)

Correspondence Address: PATRICK REILLY, BOX 7218, SANTA CRUZ, CA, 95061-7218, US

(21) Appl. No.: 10/652,610

(22) Filed: Aug. 28, 2003

(51) Int. Cl. A45C 15/06; F21V 23/04

(52) U.S. Cl. 362/156; 362/84; 362/276

(57) ABSTRACT

A lighting system, and method of manufacture thereof, for illuminating the interior of a purse, bag, pocket or other container is provided. A first version uses a portable battery to power an electroluminescent wire. Additional versions may optionally include multiple electroluminescent wires, replaceable or interchangeable electroluminescent wires, timers, sensors, programmable or reprogrammable logic, additional batteries, and/or a sew-in lip. The lighting system may be sewn-in, glued, magnetically secured or otherwise attached to a fabric of the purse, bag, pocket or container.

### FIELD OF THE INVENTION

The present invention relates to the design of fashion, clothing, clothing accessory and apparel products having interiors, such as bags or pockets. More particularly, the present invention relates to providing a lighting system to portable clothing or clothing accessories.

### BACKGROUND OF THE INVENTION

The fashion and apparel industries are major sectors in most national economies. Clothing and clothing accessories (“accessories”) are almost invariably required to be easily portable. Given acceptable cost efficiencies, significant improvements in usability and ergonomics of clothing and accessories can be widely distributed. Clothing and accessories are often used in poorly lighted conditions. The prior art efforts to increase the usability of clothing or accessories fail to provide reliable, light-weight, and sufficiently long-lived lighting to the interiors of bags or pockets.

There is, therefore, a long felt need to a lighting system that reliably provides increased visibility to objects located within an interior of an accessory or an article of clothing.

### OBJECTS OF THE INVENTION

It is an object of the present invention to provide a lighting system that provides illumination within an interior of a bag, purse, pocket or container.

It is an additional optional object of the present invention to provide a portable lighting system that is light-weight, for example is less than eight ounces in weight.

It is a further optional object of certain preferred embodiments of the present invention to provide a portable lighting system having a portable electrical energy source.

It is another optional object of certain alternate preferred embodiments of the present invention to provide a lighting system that may be sewn into a fabric of an article of clothing or an accessory.

It is yet another optional object of certain still alternate preferred embodiments of the present invention to provide a lighting system that delivers one or more colors or hues of illumination within an interior of a bag, accessory, or container.

It is a still additional optional object to provide a method to integrate a lighting system into the manufacture of a clothing accessory or an article of clothing.

### SUMMARY OF THE INVENTION

These and other objects will be apparent in light of the prior art and this disclosure. A first preferred embodiment of the present invention provides a lighting system for an interior of a clothing accessory, where the clothing accessory provides access to the interior of the accessory. The terms clothing accessory and accessory are defined herein as synonyms and their definitions includes purses, handbags, satchels, bags, and other suitable containing devices known in the art. The lighting system may include, in part or in total, (1) an electroluminescent wire (“EL wire”) substantially surrounding an axis of the interior and (2) an electrical energy source, where the electrical energy source is coupled with the electroluminescent wire. The electrical energy source provides electrical energy to the electroluminescent wire and enables the electroluminescent wire to emit light energy into the interior of the accessory. The electrical energy source may be or comprise an electrical battery, or other suitable electrical energy source known in the art.

The lighting system may further optionally include a sew-in lip. The sew-in lip may be disposed substantively about the electroluminescent wire. The sew-in lip may be attached by thread to the clothing accessory. Thread is defmed herein to include cotton thread, synthetic fiber, metallic wire, and other suitable materials and products known in the art. The electroluminescent wire or other part of the lighting system may be additionally or alternatively may be attached to the accessory by an adhesive. The lighting system of claim 1, wherein the system further comprises an adhesive, the adhesive coupled with the electrical energy source and the adhesive is for attaching the electrical energy source to the clothing accessory.

The lighting system may optionally further comprise a switch, where the switch controls the electrical connection between the electrical power source and the electroluminescent wire. The switch provides an electrical power pathway for delivering electrical current between the electrical power source and the electroluminescent wire. The switch has at least a first state and a second state, wherein sufficient electrical power is delivered to the electroluminescent wire to enable the electroluminescent wire to brighten in the first state, and wherein less on no electrical power is delivered to the electroluminescent wire in the second state. The lighting system may also provide a manual control to the switch, wherein the user may turn on or turn off the electroluminescent wire by manual setting of button or arm of the manual control.

Certain alternate preferred embodiments of the present invention may further comprise and a timer coupled with the switch. The timer may direct the switch to transition from the first state to the second state after the switch has evidenced the first state for a predetermined time period. The timer may optionally be programmable and the predetermined time period is settable by a user. The lighting system may also provide a manual control that overrides to the timer's direction to the switch, wherein the user may turn on or turn off the electroluminescent wire by manual setting of button or arm of the manual override and regardless of the activity or state of the timer.

In certain still alternate preferred embodiments of the present invention, the electroluminescent wire is detachably coupled to the electrical power source and the electroluminescent wire may be replaced with a second electroluminescent wire. Additionally or alternatively, the lighting system further provide a second electroluminescent wire, where the second electroluminescent wire may becoupled with the electrical power source.

In certain yet alternate preferred embodiments of the present invention, the lighting system may include a second electrical power source. The second electrical power source may provide electrical energy to one or more electroluminescent wires.

In addition, the lighting system may further optionally include a second switch, where the second switch is coupled with the second electrical power source and one or more electroluminescent wires. The second switch is used to turn on and turn off one or more electroluminescent wires.

In certain other alternate preferred embodiments of the present invention, the lighting system may further comprise a sensor coupled with the switch. The sensor detects a physical parameter, such as an intensity level of light, and the sensor may direct or inform the switch to assume the first state upon the detection of the physical parameter, whereby one or more electroluminescent wires are turned on. The sensor may be a motion sensor, a heat sensor, a proximity sensor, and/or light sensor.

In certain still other alternate preferred embodiments of the present invention, the system may include a surface, the surface for bearing a logo.

In certain yet other alternate preferred embodiments of the present invention, the system may include a logic circuit. The logic circuit may be configured to direct the switch to assume the first state upon the occurrence of at least one preestablished criterion, such a detection signal emitted by a sensor.

Certain alternate preferred embodiments of the method of the present invention provides a technique for an illumination of an interior of a clothing accessory by a method that includes one or more of the following steps:
providing a lighting system for the interior of a clothing accessory, the lighting system comprising and electroluminescent wire, or EL wire, and an electrical energy source;
the electroluminescent wire substantially surrounding an axis of the interior;
the electrical energy source coupled with the electroluminescent wire, and the electrical energy source providing electrical energy to the electroluminescent wire and enabling the electroluminescent wire to emit light energy into the interior;
attaching the electroluminescent wire to the clothing accessory in an orientation to allow illumination of the interior by the electroluminescent wire; attaching the electrical energy source to the clothing accessory and enabling the coupling of the electrical energy source with the electroluminescent wire; and
illuminating the interior with light energy emitted by the electroluminescent wire.

Certain other still alternate embodiments of the present invention include a housing having first plate and a second plate. The housing is coupled to both the electrical power source and the accessory. The first plate includes at least two flanges, and the second plate has a matching receiver for each flange. Each flange passes through a material or side of the accessory and a matching receiver. The flange is bent towards the material and back towards the first and second plate, whereby the housing and the electrical power source are attached to the accessory, and the electrical power source is made accessible for coupling with the electroluminescent wire.

Other aspects of the present invention include a method, system and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is an illustration of a first preferred embodiment of the present invention, or first version, having an EL wire, and a control module with a battery, and as installed in a handbag;

FIG. 2 is a schematic diagram of the control module of the first preferred embodiment of the present invention of FIG. 1 attached to a handbag;

FIG. 3 illustrates a networked manufacturing system comprising a computer network, a networked computer, a computer-readable medium and a computer based sewing system;

FIG. 4 is a flowchart of the first preferred embodiment of the method of the present invention of FIG. 3 that may be performed to manufacture the first preferred embodiment of the present invention of FIG. 2;

FIG. 5 is an illustration of the first version of FIG. 1 having a control module and an EL wire 4, wherein a sew-in lip of the EL wire is shown;

FIG. 6 is an illustration of the first version of FIG. 1 as attached to an internal fabric of the handbag;

FIG. 7 is a detailed illustration of an optional housing of the control module of the first version 2 of FIG. 1;

FIG. 8 is a more detailed illustration of the optional housing of the control module of the first version 2 of FIG. 1;

FIG. 9 is an illustration of the housing of FIG. 6 attached to an internal fabric of the handbag of FIG. 1;

FIG. 10 is an illustration showing a pair of flanges of the housing of FIG. 7 passing through apertures of the internal fabric of the handbag of FIG. 1; and

FIG. 11 shows the flanges of FIG. 7 bent or otherwise positioned to hold the control model static relative to the handbag of FIG. 1.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

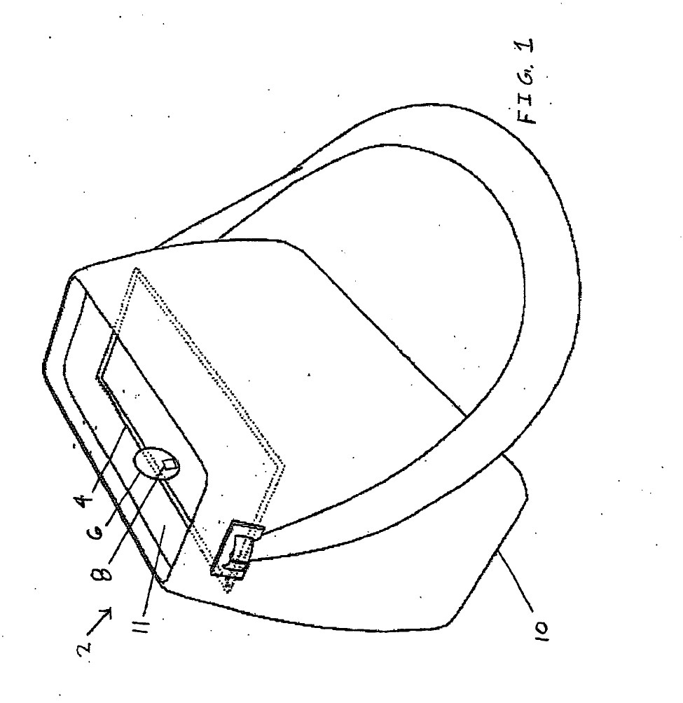

Referring now generally to the Figures and particularly to FIG. 1, FIG. 1 is an illustration of a first preferred embodiment of the present invention 2, or first version 2, having an EL wire 4, and a control module 6 with a battery 8, and as installed in a handbag 10. The control module 6 may be sized fit within a cylinder segment having a radius of one inch and a height of one inch. The EL wire 4 illuminates an interior 11 of the bag when sufficient electrical power is provided from the battery 8 and via the control module 6. The control module 6 houses the battery 8 and holds the battery 8 in a position relative to the EL wire 4, whereby the battery 8 is enabled to act as an electrical power source for the EL wire 4. The EL wire 4 may be or comprise a suitable electroluminescent wire, such as a LYTEC electroluminescent wire marketed by Electroluminescent Industries Ltd of Jerusalem, Israel.

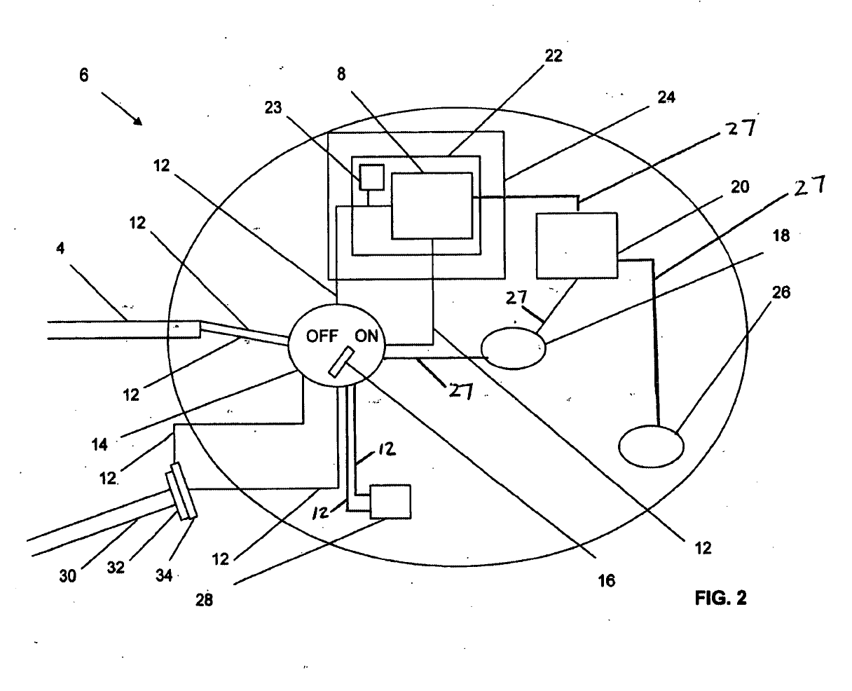

Referring now generally to the Figures and particularly to FIGS. 1 and 2, FIG. 2 displays a detailed view of the control module 6. The battery 8 provides power to the EL wire 4 via electrically conductive traces 12. A switch 14 is located in the electrical power signal pathway between the EL wire 4 and the battery 8. The switch 14 may be placed into either a first state, or “ON” state, or a second state, or “OFF” state. When the switch is on the ON, or first, state a power signal sufficient to cause the EL wire 4 illuminate is passed from the battery 8 and to the EL wire 4. When the switch is in the OFF, or second, state the power signal is wholly or substantively interrupted in flowing from the battery 8 to EL wire 4, whereby the EL wire 4 receives insufficient electrical power to illuminate. The switch 14 has manual control 16 that may be used to place the switch 14 into either the ON state or the OFF state by manual or physical manipulation of the manual control 16 by the user or other person. A timer 18 detects or is informed by a controller 20 approximately when the EL wire 4 has been turned on or begun an illumination session. The controller 20 may be a suitable digital logic processor, microprocessor, controller, microcontroller or other suitable logic device known in the art. The controller 20 may optionally be programmable, reprogrammable, field programmable, or field reprogrammable. The timer 18 then informs the controller 20 or the switch 14 when a predetermined time period has elapsed since the beginning of the illumination session. The switch 14 may thereupon end the illumination session by moving from the ON state to the OFF state, and thereby turning off the EL wire 4, in response to either the timer's information or by direction from the controller 20. The controller 20 may be or comprise a digital logic device, such as a suitable programmable logic device, a reprogrammable logic device, a microprocessor, a microcontroller, a plurality of logic gates, or other suitable electronic logic device known in the art.

The battery 8 may be comprised within an electrical power source 22 having a power conditioner 23, such as a suitable MODULE_INVERTER power conditioner as marketed by Electroluminescent Industries Ltd of Jerusalem, Israel. The battery 8 may further be or comprise, or be comprised within, a power pack 24 having an electrical power signal driver, such as a suitable POWER-PACK electrical power signal driver conditioner as marketed by Electroluminescent Industries Ltd of Jerusalem, Israel, or another suitable electrical power signal driver or modifier circuit known in the art.

A sensor 26 is positioned to detect a physical parameter, such as light, heat, proximity of an object and/or motion of an object within the interior 11 of the handbag 10. The controller 20 may send and received information and power signals via electrically conductive signal traces 27 from various electrical components of the control module 6, such as the sensor 26.

An optional extra battery 28 is provided as additional or alternate power supply to a second EL wire 30 and/or the EL wire 4. The EL wires 4, 30 may each or both comprise a detachable attachment fixture 32 that is configured to mechanically mate with a control fixture 34 of the control module 6. The power supply is electrically coupled with an EL wire 4, or 30 when the corresponding detachable attachment fixture 32 is mated with a control fixture 34. The detachability of the mating of the control fixture 34 and the detachable attachment fixture enable the control module 6 and the EL wires 4 & 30 to be separately installed or replaced in the handbag 10. A printed circuit board 35 provides a stable physical platform for the electrical and mechanical components of the control module 6, e.g., the power pack 24, signal traces 27, and the controller 20.

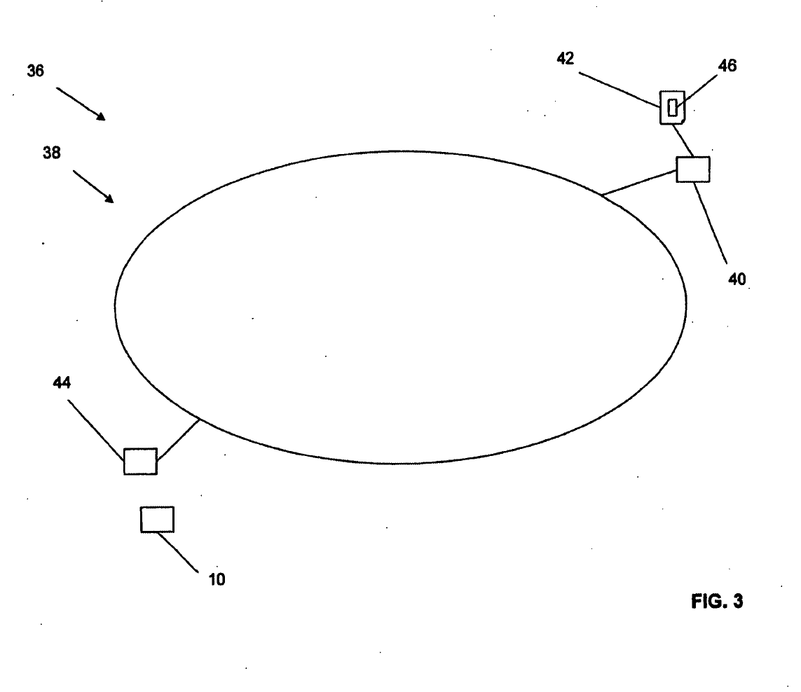

Referring now generally to the Figures and particularly to FIG. 3, FIG. 3 illustrates a networked manufacturing system 36 comprising a computer network 38, a networked computer 40, a computer-readable medium 42 and a computer based manufacturing system 44. The computer network 38 may be or comprise the Internet, an Intranet, an Extranet, a telephone network, or other suitable electronic communications system known in the art. The networked computer 40 is communicatively linked to the computer network 38, as is the computer based manufacturing system 44. The networked computer 40 may be a personal computer, a workstation, a personal digital assistant, or other suitable electronic computational device known in the art. The networked computer 40 is configured and enabled to read manufacturing instructions or data 46 from the computer-readable medium 42. The networked computer 40 formulates and transmits a manufacturing message via the computer network 38 and to the computer based sewing system. The manufacturing message may contain an operational information, where the operational information is either received or at least partially determined by the instructions or data 46 stored on the computer-readable medium 42. The computer based manufacturing system is configured and enabled to perform or support the performance of a manufacturing action, such as a sewing or adhering step, relevant to the installation of affixation of the EL wire 4 to the handbag 10 at least partially on the basis of the operational information.

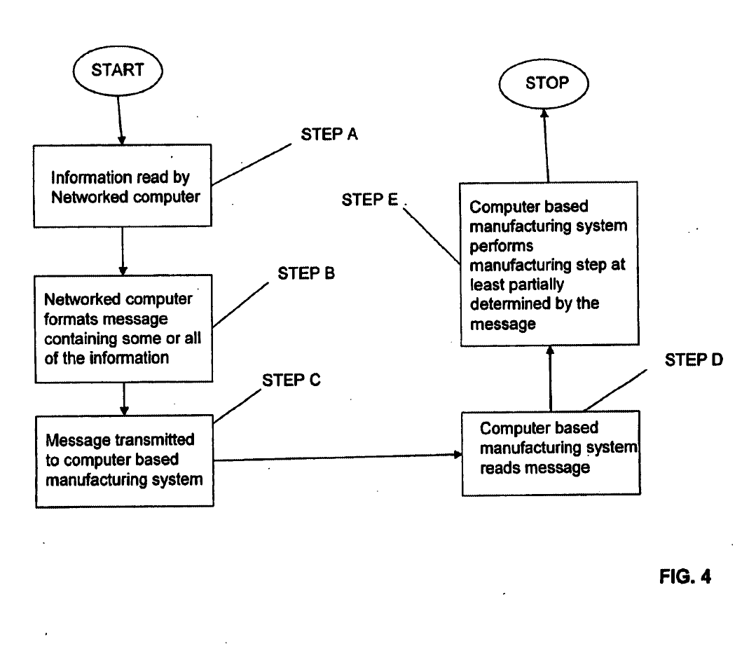

Referring now generally to the Figures and particularly to FIGS. 3 and 4, FIG. 4 is a flowchart of the first preferred embodiment of the method of the present invention of FIG. 3 that may be performed to manufacture the first preferred embodiment of the present invention of FIG. 2. In step A the networked computer 40 receives access to the computer-readable medium 42 and reads information 46 from the computer-readable medium 42. In step B the networked computer 40 formats a message containing some information either read from or at least partially derived from the information 46. In step C the message is transmitted to the computer based manufacturing system 44 via the computer network 40. In step D the computer based manufacturing system 44 reads the message and prepares a manufacturing instruction that is at least partially based on information contained within the message. In step E the computer based manufacturing system 44 performs a manufacturing step, such as a sewing action, that supports an installation of the first version 2 into the handbag 10.

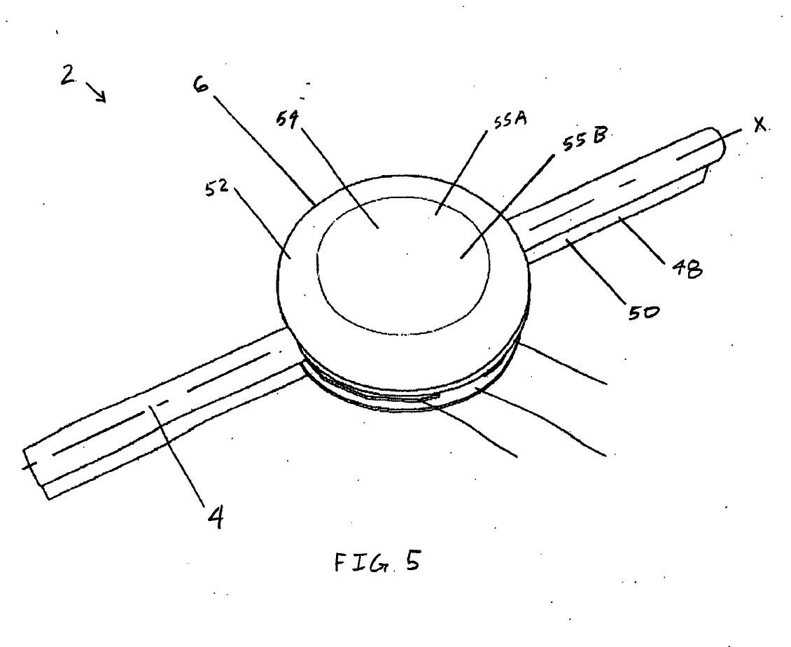

Referring now generally to the Figures and particularly to FIG. 5, FIG. 5 is an illustration of the first version 2 of FIG. 1 having the control module 6 and the EL wire 4, wherein a sew-in lip 48 of the EL wire is shown. The sew-in lip 48 may be a suitable translucent or semi-translucent material known in the art, such as a clear plastic or a color tinted plastic. The sew-in lip 48 is positioned substantively around a main axis X of the EL wire 4 and projects out from the main axis X to form an attachment area 50. The attachment area 50 may be sewn, glued, affixed or otherwise attached to the handbag 10, whereby the EL wire 4 is secured to the handbag 10 under a constraint on movement imposed by the sew-in lip 50. The control module 6 may comprise a cover 52 that protects the electronic circuits of the control module 6, e.g. the controller 20, the battery 8, and etc., from solid or liquid contamination. The cover 52 includes as surface 54 upon which a logo 55A and or a fabric 55B is imprinted or attached. The logo 55A or the fabric 55B may be chosen to aesthetically match or complement the visual appearance and or tactile nature of the handbag 10. In certain alternate preferred embodiments of the present invention some or all of the first version 2 may be partially or totally covered or enclosed in fabric 55B, leather or other suit able material known in the art. The fabric, leather or other material may be selected to enhance, complement or reflect the appearance or style of the bag. The fabric 55B can be attached to the first version 2 by adhesive, holding ring or other suitable attachment method or device known in the art.

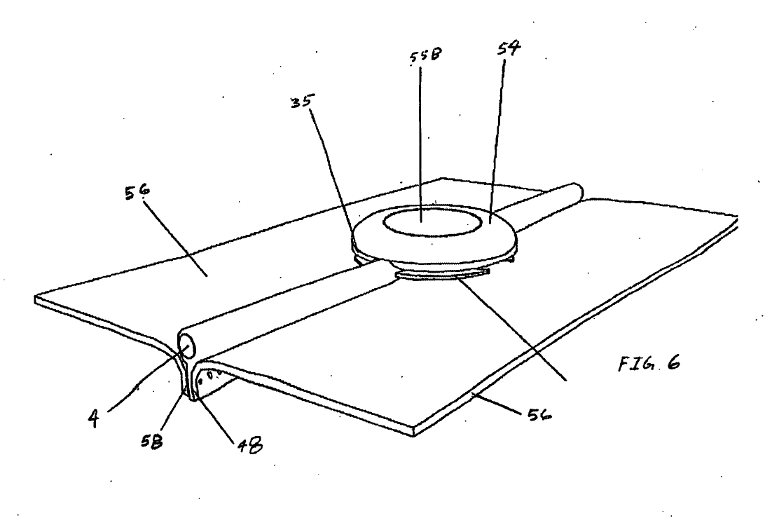

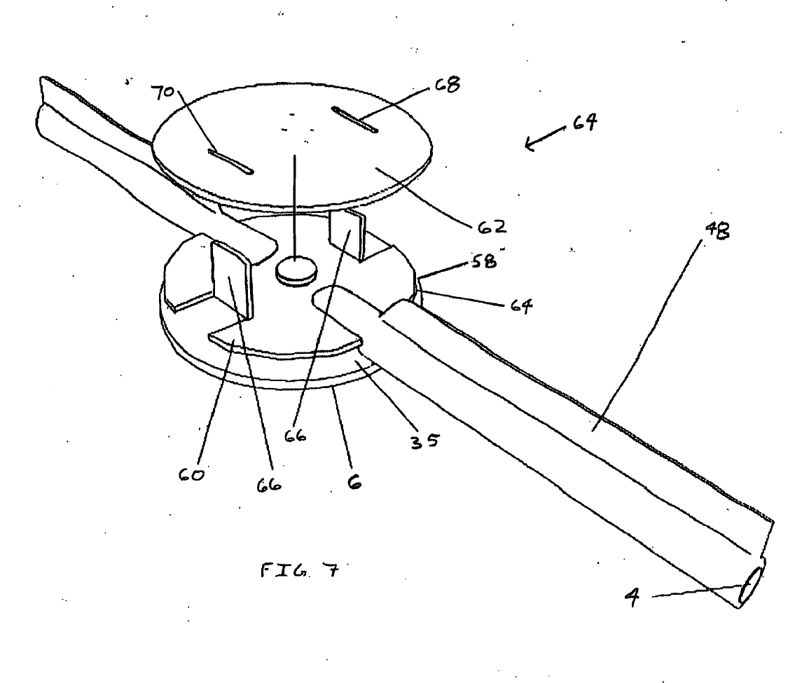

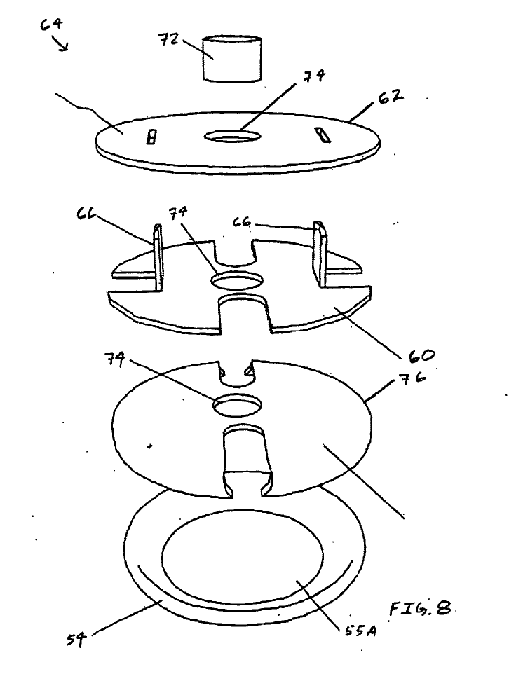

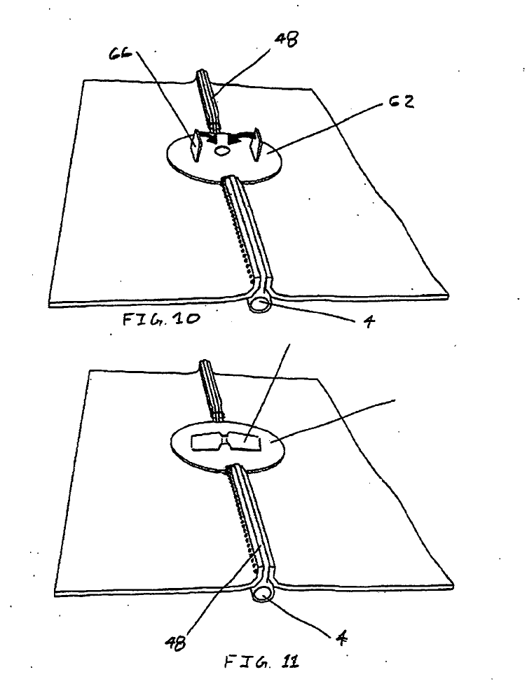

Referring now generally to the Figures and particularly to FIG. 6, FIG. 6 is an illustration of the first version 2 of FIG. 1 as attached to an internal fabric 56 of the handbag 10. The control module may be affixed to the internal fabric 56 by an adhesive 58, or by a set of plates 60, 62 of a housing 64 of the control module 6 as shown in FIGS. 7, 8, 9, 10 and 11. The housing 64 may comprise a suitable metal or plastic, or other suitable material known in the art.

Referring now generally to the Figures and particularly to FIGS. 6 and 7, FIG. 7 is a detailed illustration of the optional housing 64 of the control module 6 of the first version 2 of FIG. 1. The printed circuit board 35 of control module 6 may be affixed to an internal side 64 the first plate 60 by the adhesive 58. The first plate 60 includes at least two flanges 66 that are each sized to pass through at least one matching receiver 68 or 70 of the second plate 62. Each of the flanges 66 and are passed through the internal fabric 56 and substantially through one of the receivers 68 or 70.

Referring now generally to the Figures and particularly to FIGS. 6, 7 and 8, FIG. 8 is a more detailed illustration of the optional housing 64 of the control module 6 of the first version 2 of FIG. 1. A plug 72 may be shaped to pass through plug receivers 74 of the first plate 60, the second plate 62, and an optional under plate 76 of the control module 6. The plug 72 may pass through an aperture of the internal fabric 56 and be friction fitted into the receivers 74, whereby the housing 64 is constructed. The optional under plate 76 may optionally be detachable from the plug 72, and the printed circuit board 35 may be attached to the under plate 76, whereby one or more of the electrical or mechanical components 8, 12, 14, 16, 18, 20, 22, 24, 26, 27, 28, 34 and 56 of the control module 6 may be removed from the handbag 10 for the purpose of repair and/or replacement. Alternatively, the cover 52 may be removable to expose one or more electrical or mechanical components 8, 12, 14, 16, 18, 20, 22, 24, 26, 27, 28, 34 and 56 of the control module 54 for the purpose of repair and/or replacement. The housing 64 may comprise a suitable metal, plastic, or a composite material, or another suitable material known in the art. The control module 6 may be sized to fit within a cylindrical volume of less than one inch in radius and two inches in depth. The EL wire 4 may be or comprise an electroluminescent wire known in the art, such as a GENERAL PURPOSE LYTEC FAMILY (2.3 MM DIAMETER) as marketed by Electroluminescent Industries Ltd of Jerusalem, Israel.

Referring now generally to the Figures and particularly to FIGS. 6, 7, 8 and 9, FIG. 9 is an illustration of the housing 64 of FIG. 6 attached to the internal fabric 56 by means of capture of at least part of the internal fabric 56 by the positioning of the flanges 66 as the flanges 66 are pressed towards the second plate 62.

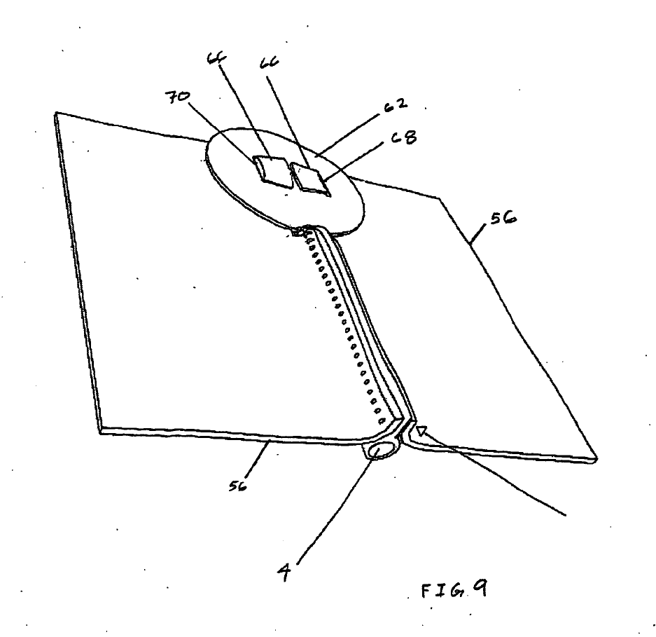

Referring now generally to the Figures and particularly to FIGS. 9, 10 and 11, FIG. 10 is an illustration showing the flanges 66 passing through apertures of the internal fabric 56 and the receivers 68 and 70. FIG. 11 shows the flanges bent or otherwise positioned to hold the control model 6 in a substantially static position relative to the internal fabric 56 and the EL wire 4.

The term “computer-readable medium” as used herein refers to any suitable medium known in the art that participates in providing instructions to a computer integrated manufacturing system for execution. Such a medium may take many forms, including but not limited to, non-volatile medium, volatile medium, and transmission medium. Non-volatile medium includes, for example, optical or magnetic disks, or other suitable data storage device known in the art. Volatile medium includes dynamic memory. Transmission medium includes coaxial cables, copper wire and wire optics. Transmission medium can also take the form of acoustic or light waves, such as those generated during radio-wave and infra-red data communications.

Common forms of computer-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable medium may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

Those skilled in the art will appreciate that various adaptations and modifications of the just-described preferred embodiments can be configured without departing from the scope and spirit of the invention. Other suitable fabrication, manufacturing, assembly, wire bonding and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A lighting system for an interior of a clothing accessory, the clothing accessory configured to provide access to the interior through an aperture, the lighting system comprising:
an electroluminescent wire, the electroluminescent wire substantially surrounding an axis of the interior; and
an electrical energy source, the electrical energy source coupled with the electroluminescent wire, and the electrical energy source providing electrical energy to the electroluminescent wire and enabling the electroluminescent wire to emit light energy into the interior.

2. The lighting system of claim 1, wherein the electrical energy source is an electrical battery

3. The lighting system of claim 1, wherein the system further comprises a sew-in lip, the sew-in lip coupled with the electroluminescent wire, and the sew-in lip for attachment by thread to the clothing accessory.

4. The lighting system of claim 1, wherein the system further comprises an adhesive, the adhesive coupled to the electroluminescent wire and the adhesive is for attaching the electroluminescent wire to the clothing accessory.

5. The lighting system of claim 1, wherein the system further comprises an adhesive, the adhesive coupled with the electrical energy source and the adhesive is for attaching the electrical energy source to the clothing accessory.

6. The lighting system of claim 1, wherein the lighting system further comprises a switch, the switch coupled with the electrical power source and the electroluminescent wire, the switch providing a pathway for delivering electrical current between the electrical power source and the electroluminescent wire, and the switch having a first state and a second state, wherein the pathway is available to the electrical power source and the electroluminescent wire in the first state, and wherein the pathway is disabled and is not available to deliver electrical current above a minimal level between the electrical power source and the electroluminescent wire in the second state.

7. The lighting system of claim 6, wherein the system further comprises and a timer, wherein the timer is coupled with the switch, and the timer directs the switch to transition from the first state to the second state after the switch has evidenced the first state for a predetermined time period.

8. The lighting system of claim 7, wherein the timer is programmable and the predetermined time period is settable by a user.

9. The lighting system of claim 6, wherein the electroluminescent wire is detachably coupled to the electrical power source, whereby the electroluminescent wire may be replaced with a second electroluminescent wire.

10. The lighting system of claim 6, wherein the lighting system further comprises a second electroluminescent wire, the second electroluminescent wire coupled with the electrical power source and wherein the electrical power source provides electrical energy to the second electroluminescent wire.

11. The lighting system of claim 6, wherein the lighting system further comprises a second electroluminescent wire and a second electrical power source, the second electroluminescent wire coupled with the second electrical power source and wherein the second electrical power source provides electrical energy to the second electroluminescent wire.

12. The lighting system of claim 11, wherein the lighting system further comprises a second switch, the second switch coupled with the second electrical power source and the second electroluminescent wire, the second switch providing a second pathway for delivering electrical current between the second electrical power source and the second electroluminescent wire, and the second switch having an open state and a closed state, wherein the second pathway during an occurrence of the open state of the second switch is available to the second electrical power source and the second electroluminescent wire during an occurrence of the open state of the second switch, and wherein the second pathway is disabled and is not available to deliver electrical current above a minimal level between the second electrical power source and the second electroluminescent wire during an occurrence of the closed state of the second switch.

13. The lighting system of claim 6, wherein the lighting system further comprises a sensor, the sensor coupled with the switch, and the sensor for detecting a physical parameter and the sensor directing the switch to assume the first state upon the detection of the physical parameter.

14. The lighting system of claim 13, wherein the sensor is a motion sensor and the physical sensor is relative movement of an object within the interior.

15. The lighting system of claim 13, wherein the sensor is a heat sensor and the physical parameter is a predetermined level of heat energy.

16. The lighting system of claim 13, wherein the sensor is a proximity sensor and the physical parameter is a proximity of an object to the sensor.

17. The lighting system of claim 13, wherein the sensor is a light energy sensor and the physical parameter is a predetermined level of light energy.

18. The lighting system of claim 1, wherein the system further comprises a surface, the surface for bearing a logo.

19. The lighting system of claim 6, wherein the system further comprises a logic circuit, the logic circuit configured to direct the switch to assume the first state upon the occurrence of at least one pre-established criterion.

20. The lighting system of claim 19, wherein the system further comprises a second electroluminescent wire and a second switch, the second switch coupled with the electrical power source and the second electroluminescent wire, the second switch providing a second pathway for delivering electrical current between the electrical power source and the second electroluminescent wire, and the second switch having an open state and a closed state, wherein the second pathway during an occurrence of the open state of the second switch is available to the electrical power source and the second electroluminescent wire, and wherein the second pathway is disabled and is not available to deliver electrical current above a minimal level between the electrical power source and the second electroluminescent wire during an occurrence of the closed state of the second switch.

21. The method of claim 6, wherein the switch is manually operable and the switch may be moved between the first state and the second state by manual selection of the switch.

22. The lighting system of claim 6, wherein the lighting system further comprises:
a housing having first plate and a second plate, wherein housing is coupled to both the electrical power source and the accessory;
the first plate includes at least two flanges, and the second plate has a matching receiver for each flange;
each flange passes through a material of the accessory and a matching receiver; and
at least one flange is bent towards the material and back towards the first and second plate, whereby the housing and the electrical power source are attached to the accessory, and the electrical power source is made accessible for coupling with the electroluminescent wire.

23. A method of illuminating an interior of a clothing accessory, the clothing accessory configured to provide access to the interior through an aperture, the method comprising:
providing a lighting system for the interior of a clothing accessory, the lighting system comprising and electroluminescent wire and an electrical energy source;
the electroluminescent wire substantially surrounding an axis of the interior;
the electrical energy source coupled with the electroluminescent wire, and the electrical energy source providing electrical energy to the electroluminescent wire and enabling the electroluminescent wire to emit light energy into the interior;
attaching the electroluminescent wire to the clothing accessory in an orientation to allow illumination of the interior by the electroluminescent wire;
attaching the electrical energy source to the clothing accessory and enabling the coupling of the electrical energy source with the electroluminescent wire; and
illuminating the interior with light energy emitted by the electroluminescent wire.
